(19) United States
(12) Patent Application Publication
(10) Pub. No.: US 2015/0196132 A1
(43) Pub. Date: Jul. 16, 2015

(54) MATTRESS CATEGORISATION TOOL

(71) Applicants: David Duffy, Naas (IE); Michael Lynch, Blessington (IE); Duncan Bain, Kings Langley (GB)

(72) Inventors: David Duffy, Naas (IE); Michael Lynch, Blessington (IE); Duncan Bain, Kings Langley (GB)

(73) Assignee: Kayfoam Woolfson, Dublin (IE)

(21) Appl. No.: 14/414,996

(22) PCT Filed: Jul. 20, 2012
(86) PCT No.: PCT/EP2012/064345

§ 371 Date: Jan. 15, 2015

(51) Int. Cl. A47C 31/12; G01M 99/00

(52) U.S. Cl. CPC A47C 31/123; G01M 99/001

(57) ABSTRACT

The present invention is directed to a mattress measurement tool (100). The mattress measurement tool (100) comprises mattress-engaging pads (110A, 110B), where the mattress-engaging pads (110A, 110B) are located at each free end of the substantially horizontal cross-member (108). The mattress measurement tool (100) further comprises a distance measuring device (118) for measuring a conformity characteristic of the mattress. The mattress measurement tool (100) is capable of measuring support, conformity and rebound of the mattress.

Reference is hereby made to a related PCT Patent Application, namely PCT/EP2011/071,569 also filed in the name of KAYFOAM WOOLFSON, which is directed to a device for categorizing individuals according to certain criteria so that a mattress with the optimal characteristics for that individual's body type may be correctly selected for the individual.

This invention relates to a mattress measuring tool and in particular to a mattress categorization tool.

In furtherance, the present invention is directed to a mattress categorisation tool which may be used in conjunction with the system of the above-identified PCT Patent Application so as to standardise the categorisation of mattresses for consistency for use with the system. The tool of the present invention categorises mattress in one of a preset number of mattress types and the system of the above-identified PCT Patent Application categorises individual's body types into one of a number of prescribed body types, where, through research and knowledge the preset number of mattress types and the number of prescribed body types have been matched so that the correct mattress may be recommended for each body type.

In using the system of the above-identified PCT Patent Application, it is important that the mattresses, which may emanate from a number of different manufacturers and be subject to different national and regional regulations, are measured and categorised according to a standardised scheme to allow for accurate and reliable comparison.

As is well known, it is important for individuals to sleep on mattresses which are suited to that individual's body type. Different mattresses have different characteristics and the characteristics of the mattress will affect the quality of sleep which the individual will experience. From research, it has been found that a mattress comprises three important characteristics, namely, support, conformity and rebound, which is also known as viscosity.

Support is essentially the firmness of the mattress itself which ranges from a soft support to a hard/firm support. This may be quantified in terms of the distance deflected under a given force, or in terms of the force required to produce a given deflection.

The conformity characteristic is a measurement of the ability of the mattress to deform around an individual's body, without the neighbouring parts of the mattress also deforming and deflecting; it is in essence a measurement of the localisation effect of the deflection of the mattress, which is to say, the ability of neighbouring parts of a surface of the mattress to deform or deflect, independently of each other.

Finally, viscosity, which is the inverse of rebound, and consequently may be referred to as such by way of reference to rebound throughout the following specification, is the speed at which a surface of a mattress will recover to its original shape following deflection, when a load causing the deflection has been removed. This has implications on the ease of rolling over or otherwise changing a sleeping position when lying on the mattress, which is an important consideration for certain body types.

If an individual has a particular body type, then the correct combination of these three important characteristics will provide the individual with a suitable mattress for their body type. By way of example, a curvy S-spine, with a number of prominences will require a certain amount of yield in the mattress, and such a body type is best suited to a mattress with high conformity. As a further example, a heavy set individual should preferably use a mattress with a lot of support thus preventing the individual from sinking into the mattress to much which would prevent the individual from turning during their sleep.

It is therefore vital that the characteristics of the mattresses on offer are accurately measured and standardised so that the different mattresses available to an individual from different manufacturers may be compared for suitability for that individual's body type.

It is known from the prior art to measure the support, or hardness, the mattress through various techniques. One such technique involves dropping a weighted ball onto the mattress and observing the rebound height of the weighted ball.

A further example is the Mattress Testing Machine offered by Dongguan Haida Equipment Company Limited which comprises a spherical protrusion at the bottom of a rigid, circular plate which is indented against a mattress and records the force curve and displacement for subsequent analysis. The Mattress Testing Machine comprises a framework having a pair of legs and single mattress-engaging spherical protrusion. It is believed that the Mattress Testing Machine uses a load cell to record the force values. The Mattress Testing Machine only measures support.

There are further examples of machines for measuring the hardness of the mattress, but all of these machines only use a single mattress-engaging element and are not suited for carrying out any other mattress characteristic measurements.

It is a goal of the present invention to provide an apparatus that overcomes at least one of the above mentioned problems but providing a mattress measurement machine which measures a multitude of mattress characteristics, and in particular a mattress categorisation tool capable of measuring support, conformity and viscosity.

### SUMMARY OF THE INVENTION

The present invention is directed to a mattress measurement tool comprising a substantially vertical mast supporting an outwardly extending, substantially horizontal, vertically adjustable arm; the arm having a actuator positioned at a free end; the actuator comprising an actuatable actuator shaft, wherein the actuatable actuator shaft actuates in a substantially vertical direction and supports a substantially horizontal cross-member and mattress-engaging pads; a mattress-engaging pad located at each free end of the substantially horizontal cross-member; and, the mattress measurement tool further comprising a distance measuring device for measuring a distance from a prescribed point on the mattress measurement tool to a mattress under measurement.

The advantage of providing the mattress measurement tool with a mattress-engaging pad located at each free end of the substantially horizontal cross-member and a distance measuring device is that the same mattress measurement tool can be used to measure support, conformity and viscosity/rebound. Without having at least two mattress-engaging pads, and in particular, a mattress-engaging pad located remotely from one another at each free end of the substantially horizontal cross-member, then it would not be possible to measure the conformity of a mattress using the method as established later in this specification.

In a further embodiment, the mattress measurement tool further comprises an actuator activation lever which controls the actuation of the actuator shaft in the substantially vertical direction.

In a further embodiment, the actuator activation lever may be set to actuate the actuator shaft in a upward direction such that the force of actuating the actuator shaft in the upward direction is substantially equal to the weight of the substantially horizontal cross-member and the mattress-engaging pads supported from the actuator shaft, thus simulating the mattress-engaging pads to be weightless.

This feature is particularly advantageous as it allows the rebound rate of a mattress to be measured, thus indicating the viscosity of the mattress. It is well known that the measuring device should not affect the measurement itself, arranging the actuation of the actuator in an upward direction to cause all of the component parts of the mattress measurement device, primarily the cross-member and the mattress-engaging pads, which are suspended from the actuator shaft, so as to become effectively weightless allows the rebound rate to be accurately measured. It will be readily understood that the rebound rate is the rate at which the mattress rebounds to its at-rest state.

In a further embodiment, with the substantially vertical mast arranged adjacent a side of the mattress under measurement, the length of the arm is dimensioned to outwardly extend the mattress-engaging pads over the mattress under measurement above a position where a user would typically sleep.

This is advantageous as it allows the correct part of the mattress to be measured; namely, the area of the mattress on which the user will sleep. Oftentimes, walls and the like are used in a mattress to give the mattress a defined in shape and the characteristics of the mattress will consequently vary when measurements are taken along, or adjacent, the side of the mattress as opposed to on an area removed from the side of the mattress.

In a further embodiment, the mattress measurement tool further comprises a lock to retain the outwardly extending, substantially horizontal, vertically adjustable arm at a selected height on the substantially vertical mast.

In a further embodiment, the mattress measurement tool comprises rebound rate means to measure a rebound rate of the mattress-engaging pads when the mattress-engaging pads have been simulated to be weightless and the mattress under measurement is solely acting to move the mattress-engaging pads in an upward direction.

In a further embodiment, the rebound rate means comprises a start switch and a stop switch; the start switch located on the actuator and the stop switch located on the actuator at a preset distance above the start switch; the start switch and stop switch being activatable by the actuator shaft when the actuator shaft travels past the start switch and the stop switch respectively; and, a timer unit connected to the start switch and stop switch to measure the time period taken for the mattress-engaging pads to travel the preset distance.

This is seen to be advantageous as it allows the movement of the actuator shaft to start and stop a timer for measuring the rebound rate of the mattress.

In a further embodiment, the mattress measurement tool further comprises a user display.

In a further embodiment, the mattress measurement tool comprises a pair of mattress-engaging pads, whereby the pair of mattress-engaging pads are arranged at the free ends of the cross-member with a gap therebetween.

In a further embodiment, the actuator is a pneumatic actuator. In a further embodiment, the actuator is a hydraulic ram. In a further embodiment, the actuator is an electronic actuator. In a further embodiment, the actuator is a prime mover.

The present invention is further directed towards a method of measuring a conformity characteristic of a mattress using the mattress measurement tool of any of the preceding claims, wherein, the method comprises the steps of actuating the actuator to indent the mattress-engaging pads into the mattress under measurement; and, determining the deflection of the mattress under measurement when the mattress engaging pads are indented to measure the conformity characteristic of the mattress.

This method is advantageous as the conformity characteristic of the mattress maybe relatively simply obtained by measuring a deflection of a point on a mattress under measurement from its at-rest state and when the mattress-engaging pads have been indented into the mattress under measurement. This relatively simple technique can be used to provide an accurate reading which is a good indication of the conformity characteristic of the mattress. In essence the conformity measurement is being made of the deflection of an unloaded region of a surface of the mattress, adjacent to a loaded region of the surface of the mattress. A measure of high conformity would result in a high value of deflection from the original shape, as this would indicate high independence of the two regions on the surface of the mattress.

In a further embodiment, the method comprises the steps of vertically adjusting the arm on the mast so that the mattress-engaging pads rest on the mattress under measurement; measuring the distance from the prescribed point on the mattress measurement tool to a selected point on the mattress under measurement, where the selected point is substantially between the mattress-engaging pads; actuating the actuator to indent the mattress-engaging pads into the mattress under measurement; measuring the distance from the prescribed point on the mattress measurement tool to the selected point on the mattress under measurement; and, determining the deflection of the mattress under measurement, by calculating the difference in the distance from the prescribed point to the selected point, when the mattress-engaging pads are resting on the mattress under measurement, and, when the mattress engaging pads are indented into the mattress under measurement, to measure the conformity characteristic of the mattress.

It will be readily understood that the length of the cross-member which sets the distance between the mattress-engaging pads; the diameter of the mattress engaging pads themselves; and, the depth of indentation of the mattress-engaging pads into a mattress under measurement are all inter-related in the sense that the depth of indentation, which may be preferably 85 mm, is set to add depth to ensure that all of the components parts of the mattress, such as the foam layers, springs and the like are being measured to give an accurate indication of the characteristics of the mattress. For example, if the dimensions of the mattress-engaging pads were reduced, then the depth of indentation may be reduced.

In a further embodiment, the selected point is substantially midway between the mattress-engaging pads. Taking the measurement at the selected point when it is substantially midway between the mattress-engaging pads, ensures that the measurement is being taken at the point where the maximum deflection is likely to occur, thus providing the most accurate results.

In a further embodiment, the distance measuring device for measuring the distance from the prescribed point on the mattress measurement tool to the selected point on the mattress under measurement is a callipers mounted on the cross-member and arranged to measure a distance from the cross-member down to the mattress under measurement beneath the cross-member; whereby the method comprises the steps of extending the callipers downwards to abut against the selected point on the mattress under measurement, when the mattress-engaging pads have been vertically adjusted to rest on the mattress under measurement; calibrating the callipers to a zero reading point; retracting the callipers upwards to allow the actuator to be actuated so as to indent the mattress-engaging pads into the mattress under measurement; and, re-extending the callipers downward to abut against the selected point on the mattress under measurement so as to measure the deflection of the mattress under measurement when the mattress engaging pads are indented.

The present invention is further directed towards a method of measuring a rebound characteristic of a mattress using the mattress measurement tool of any of the preceding claims, wherein, the method comprises the steps of vertically adjusting the arm on the mast so that the mattress-engaging pads are positioned over the mattress under measurement; actuating the actuator to extend the actuator shaft downward so that the mattress-engaging pads indent into the mattress under measurement; releasing the actuator to cease the extension of the actuator shaft downward and immediately actuating the actuator to retract the actuator shaft in a upward direction such that the force of retracting the actuator shaft in the upward direction is substantially equal to the weight of the substantially horizontal cross-member and the mattress-engaging pads which are supported from the actuator shaft, thus simulating the mattress-engaging pads to be weightless; and, measuring the rebound characteristic of the mattress under measurement, when the mattress-engaging pads have been simulated to be weightless and the mattress under measurement is solely acting to move the mattress-engaging pads in an upward direction.

It is advantageous to measure the rebound rate in this manner as it is well known that the measuring device should not affect the measurement itself. By causing the actuation of the actuator in an upward direction so as to effectively eliminate the weight of the component parts of their mattress measurement device, primarily the cross-member and the mattress-engaging pads, which are suspended from the actuator shaft, to become effectively weightless allows the rebound rate to be accurately measured. It will be readily understood that the rebound rate is the rate at which the mattress rebounds to return to an at-rest state.

In a further embodiment, the step of measuring the rebound characteristic of the mattress under measurement is achieved by measuring the speed of the mattress-engaging pads moving in the upward direction.

In a further embodiment, the step of measuring the rebound characteristic of the mattress under measurement is achieved by measuring the time period taken for the mattress-engaging pads to move a preset distance in the upward direction.

In a further embodiment, the method comprises the steps of using the actuator shaft to activate a start switch of a timer; using the actuator shaft to subsequently activate a stop switch on the timer, where the stop switch is located a present distance above the start switch; and, determining the time period taken for the mattress-engaging pads to move the preset distance in the upward direction to indicate the rebound characteristic for the mattress.

In a further embodiment, the actuator shaft is used to activate a lower reed switch acting as the start switch and an upper reed switch acting as the stop switch, where both the lower and upper reed switches are located on the actuator, and, the output signals from both the lower reed switch and upper reed switch are transmitted to a signal-controlled timer.

In a further embodiment, the timer comprises signal cancellation means to filter the output signals from both the lower reed switch and upper reed switch so as to remove noise and spurious signals, and, produce a single start signal and a single stop signal for use by the signal-controlled timer.

In a further embodiment, the step of actuating the actuator to extend the actuator shaft downward so that the mattress-engaging pads indent into the mattress under measurement comprises, indenting the mattress-engaging pads into the mattress under measurement to a depth in the range of 75 mm to 100 mm.

In a further embodiment, the step of actuating the actuator to extend the actuator shaft downward so that the mattress-engaging pads indent into the mattress under measurement comprises indenting the mattress-engaging pads into the mattress under measurement to a depth of substantially 85 mm.

### DETAILED DESCRIPTION OF EMBODIMENTS

The invention will be more clearly understood from the following description of some embodiments thereof, given by way of example only, with reference to the accompanying drawings, in which:

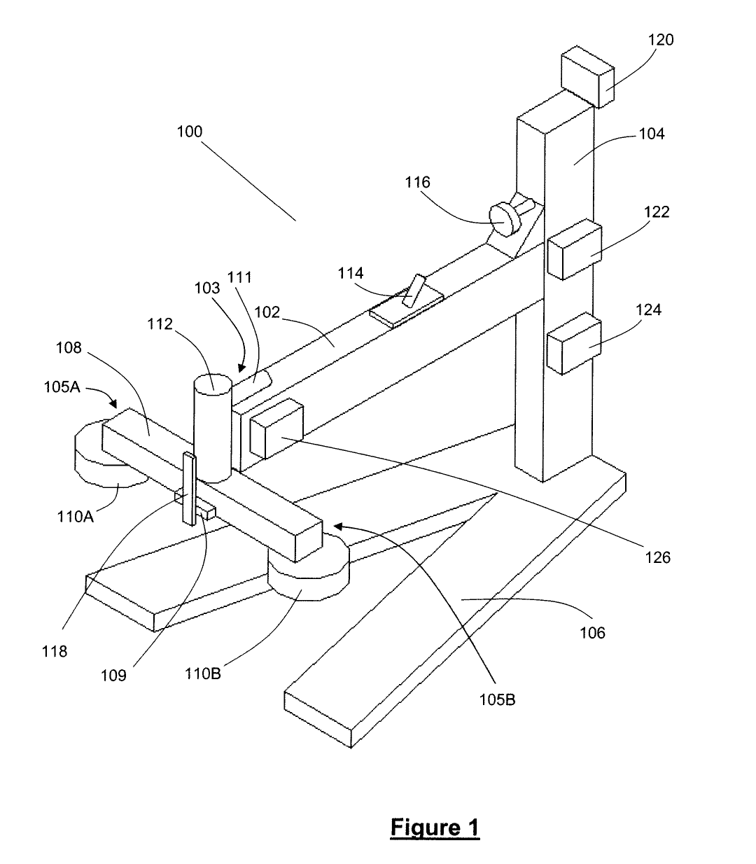

FIG. 1 is a perspective view of a mattress measurement tool in accordance with the present invention;

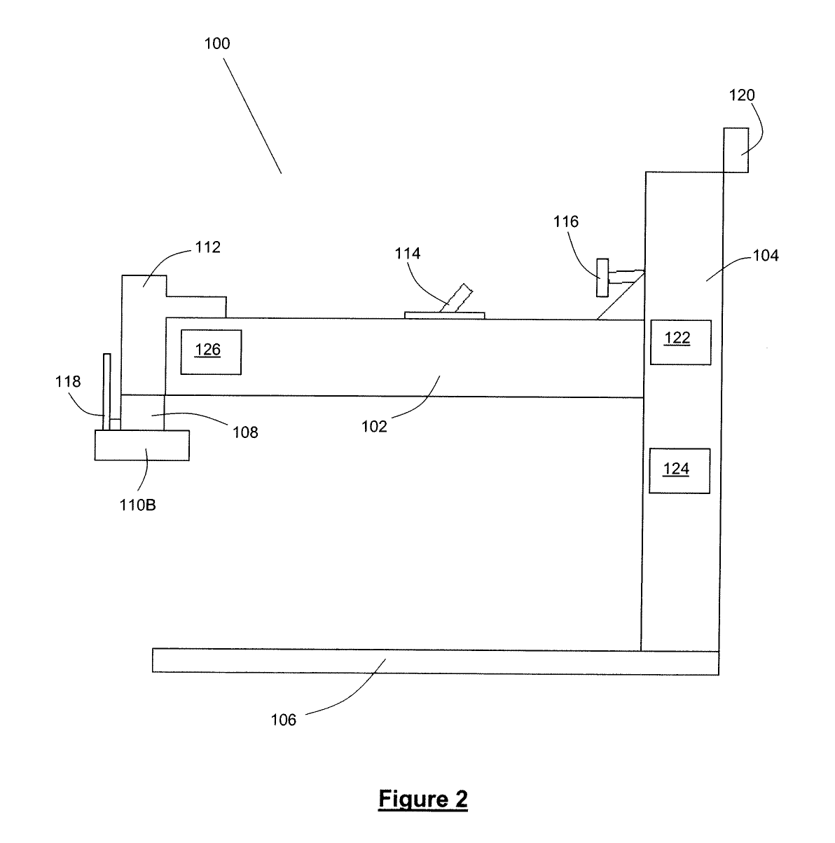

FIG. 2 is a side elevation view of the mattress measurement tool of FIG. 1;

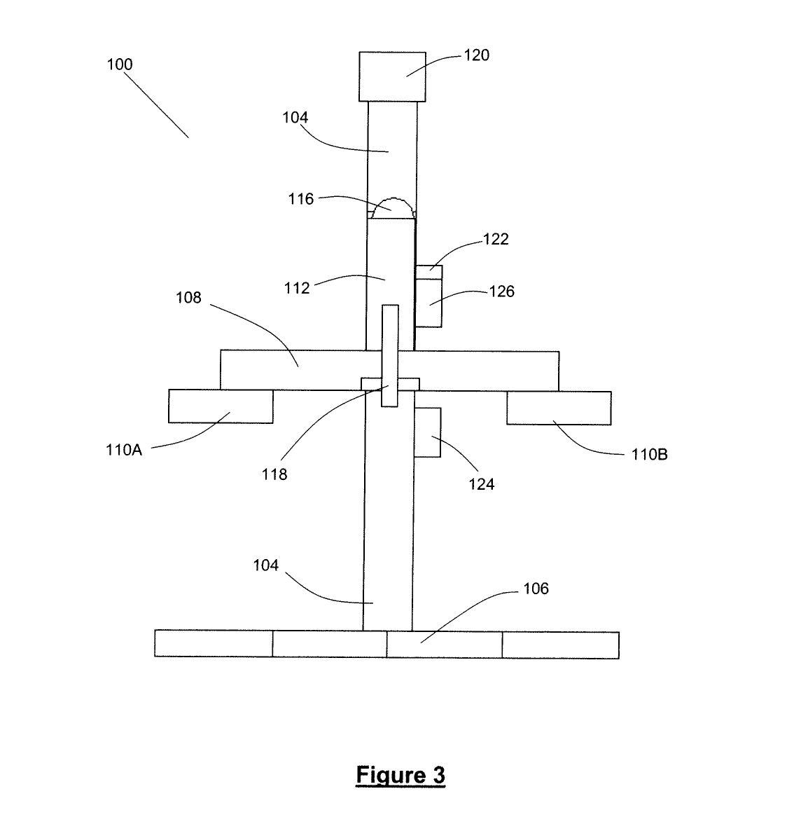

FIG. 3 is a front elevation view of the mattress measurement tool of FIG. 1;

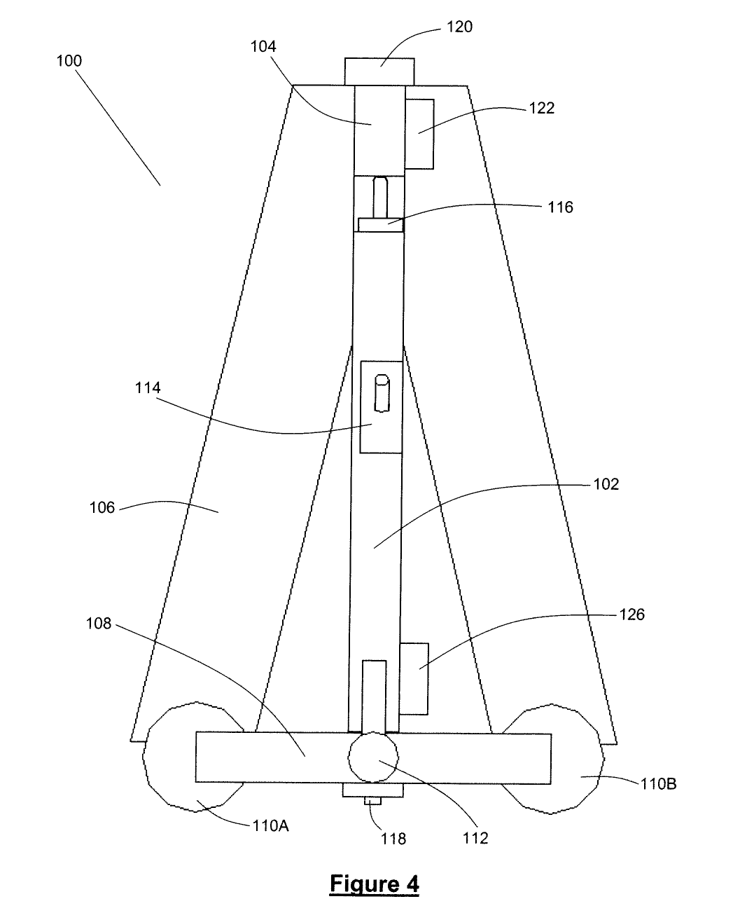

FIG. 4 is a plan view of the mattress measurement tool of FIG. 1; and,

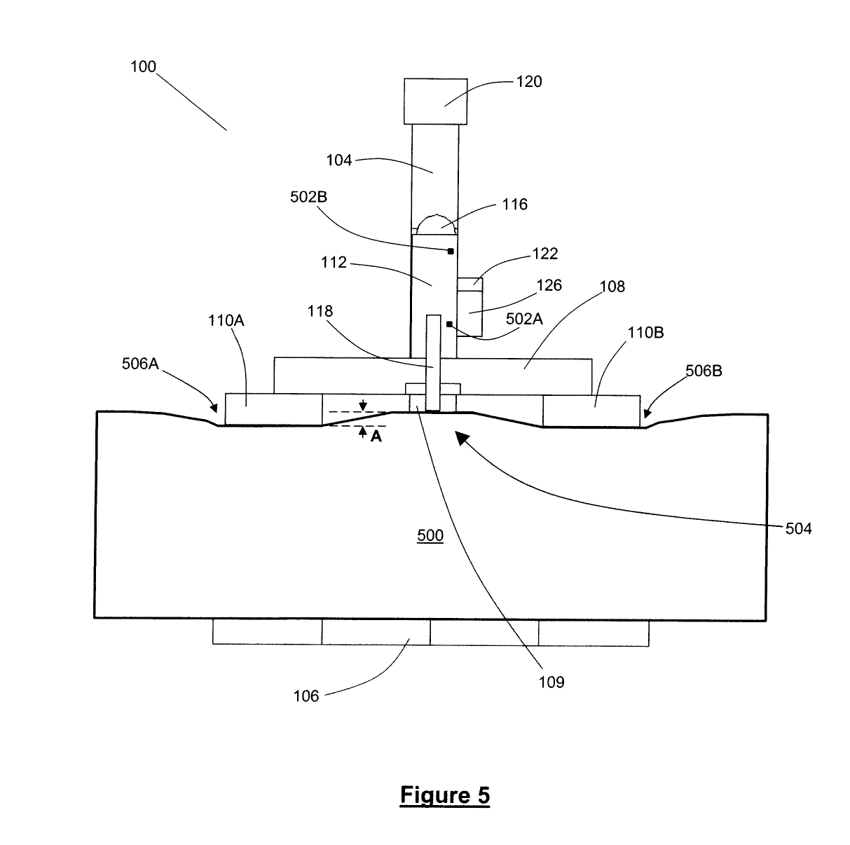

FIG. 5 is a front elevation view of the mattress measurement tool of FIG. 1 measuring a conformity characteristic of a mattress under measurement.

Referring to FIGS. 1 to 4 inclusive, there is provided a mattress measurement tool indicated generally by reference numeral 100. The mattress measurement tool 100 comprises a substantially vertical mast 104 which supporting an outwardly extending, substantially horizontal, vertically adjustable arm 102. The substantially vertical mast 104 is connected to a base 106 which extends outwardly in substantially the same direction as the outwardly extending, substantially horizontal, vertically adjustable arm 102, and to substantially the same distance outwardly as the outwardly extending, substantially horizontal, vertically adjustable arm 102. The outwardly extending, substantially horizontal, vertically adjustable arm 102 has a pneumatic actuator 112 positioned at a free end 103 of the arm 102. The pneumatic actuator 112 comprises an actuatable pneumatic actuator shaft (not shown) which actuates in a substantially vertical direction upwardly and downwardly as required. The pneumatic actuator shaft supports a substantially horizontal cross-member 108 and a pair of mattress-engaging pads 110A, 1108. A mattress-engaging pad 110A, 1108 is located at each free end 105A, 105B of the substantially horizontal cross-member 108. The mattress measurement tool 100 further comprises a distance measuring device 118 for measuring a distance from a prescribed point 119 on the mattress measurement tool to a mattress under measurement (not shown).

The outwardly extending, substantially horizontal, vertically adjustable arm 102 slides vertically up and down the substantially vertical mast 104, and may be locked in place at a desired height by a lock 116.

A pneumatic actuator actuation lever 114 is provided to turn the downward actuation of the actuator shaft on and off, and a pneumatic actuator pressure regulator 124 is provided for safety. A pneumatic regulator 126 is provided which can be adjusted so as to actuate the pneumatic actuator shaft in an upward direction with a force of substantially equal to the weight of the cross-member 108 and the mattress-engaging pads 110A, 110B.

A load cell 111 is located on the mattress measurement tool to measure the force exerted by the mattress under measurement against the mattress-engaging pads, through the pneumatic actuator shaft.

A timer 122 is provided to measure the rebound rate of the mattress under measurement. A user display 120 may also be provided to provide the user with instructions as to how to operate the mattress measurement tool 100, and the measurement readings taken during the use of the mattress measurement tool 100.

In use, and with reference to FIGS. 1 to 5 inclusive, the mattress measurement tool 100 is used to measure the support of a mattress under measurement 500 by indenting the mattress-engaging pads 110A, 110B into the mattress 500 a preset distance and subsequently using the load cell 111 to measure the force back from the mattress under measurement 500. The support measurement may be given in Newtons or may be normalized against any appropriate scale.

In further use, and with continued reference to FIG. 5, the rebound rate of the mattress under measurement 500 is obtained by indenting the mattress-engaging pads 110A, 1108 into the mattress under measurement 500 to a preset distance. It has been found that a distance of approximately 85 mm is a sufficient distance to ensure an accurate measurement of the mattress under measurement 500, although it will be readily understood that any preset distance may be used provided that the distance is sufficient to ensure that all of the component parts, such as foams and springs, of the mattress are contributing to the effect of the measurement.

Once the mattress-engaging pads 110A, 110B have been indented into the mattress under measurement 500, through the actuation of the pneumatic actuator 112 to move the pneumatic arm shaft downward, the actuation of the pneumatic actuator 112 is ceased, and an actuation of the pneumatic actuator 112 to cause the actuator shaft to retract upwardly with a force of substantially equal to the weight of the cross-member 108 and the mattress-engaging pads 110A, 1106, is applied by the pneumatic regulator 126. Thus, the mattress-engaging pads 110A, 110B are indented into the mattress under measurement 500 to a preset distance and are subsequently caused to be effectively weightless so that the rebound of the mattress under measurement 500 acts solely to move the mattress-engaging pads 110A, 110B in an upward direction.

The movement of the mattress-engaging pads 110A, 110B in the upward direction causes the pneumatic actuator shaft to move upwardly. This movement of the pneumatic actuator shaft upwardly causes the pneumatic actuator shaft to pass by a lower start reed switch 502A which sends an electronic signal to the timer 122 to begin timing. At a preselected distance above the lower start reed switch 502A, the upper stop reed switch 502B is located to cause the passing of the actuator shaft within the actuator casing to send an electronic signal from the upper stop reed switch 502B to the timer 122. The time period taken for the mattress under measurement 500 to raise the mattress-engaging pads 110A, 110B this preset distance gives a measurement of the rebound rate of the mattress under measurement 500.

Finally, in order to measure the conformity characteristic of the mattress under measurement 500, a initial reading of the distance from a point 109 on the cross-member 108 of the mattress measurement tool 100 to the mattress under measurement 500 is taken by the distance measuring device 118 when the mattress-engaging pads 110A, 110B are held were most from the mattress under measurement 500. The mattress-engaging pads 110A, 1106 are subsequently indented into the mattress through the actuation of the actuator 112 which lowers the actuator shaft, thus lowering the cross-member 108 and the mattress-engaging pads 110A, 1108 connected to the free end of the cross-member 108.

A second reading is then taken by the distance measuring device 118 of the distance from the point 109 on the mattress measurement tool 100 to the mattress under measurement 500. The difference in the distance between the first reading and the second reading taken by the distance measuring device 118 is indicative of the deflection of the mattress under measurement when the mattress-engaging pad 110A, 110B are indented into the mattress under measurement 500. As mentioned hereinbefore, this is in essence a measurement of the localisation effect of the mattress by determining how neighbouring parts of the mattress are affected when a weight is placed onto the mattress.

The timer 122 may preferably use a signal cancellation module to filter spurious electronic signals from the lower start reed switch 502A and the upper stop reed switch 502B so that a definitive start and stop signal is provided to the timer 122 unit.

It is envisaged that the mattress measurement tool may be used on a production line to quality check each of the mattresses on that production line.

The terms “comprise” and “include”, and any variations thereof required for grammatical reasons, are to be considered as interchangeable and accorded the widest possible interpretation.

It will be understood that the components shown in any of the drawings are not necessarily drawn to scale, and, like parts shown in several drawings are designated the same reference numerals.

The invention is not limited to the embodiments hereinbefore described which may be varied in both construction and detail.

1. A mattress measurement tool comprising:
a substantially vertical mast supporting an outwardly extending, substantially horizontal, vertically adjustable arm;
the arm having an actuator positioned at a free end;
the actuator comprising an actuatable actuator shaft, wherein the actuatable actuator shaft actuates in a substantially vertical direction and supports a substantially horizontal cross-member and mattress-engaging pads;
a mattress-engaging pad located at each free end of the substantially horizontal cross-member; and,
a distance measuring device for measuring a distance from a prescribed point on the mattress measurement tool to a mattress under measurement.

2. The mattress measurement tool as claimed in claim 1, wherein, the mattress measurement tool further comprises an actuator activation lever which controls the actuation of the actuator shaft in the substantially vertical direction.

3. The mattress measurement tool as claimed in claim 2, wherein, the actuator activation lever may be set to actuate the actuator shaft in a upward direction such that the force of actuating the actuator shaft in the upward direction is substantially equal to the weight of the substantially horizontal cross-member and the mattress-engaging pads supported from the actuator shaft, thus simulating the mattress-engaging pads to be weightless.

4. The mattress measurement tool as claimed in claim 1, wherein, with the substantially vertical mast arranged adjacent a side of the mattress under measurement, the length of the arm is dimensioned to outwardly extend the mattress-engaging pads over the mattress under measurement above a position where a user would typically sleep.

5. The mattress measurement tool as claimed in claim 1, wherein, the mattress measurement tool further comprises a lock to retain the outwardly extending, substantially horizontal, vertically adjustable arm at a selected height on the substantially vertical mast.

6. The mattress measurement tool as claimed in claim 1, wherein, the mattress measurement tool comprises rebound rate means to measure a rebound rate of the mattress-engaging pads when the mattress-engaging pads have been simulated to be weightless and the mattress under measurement is solely acting to move the mattress-engaging pads in an upward direction.

7. The mattress measurement tool as claimed in claim 6, wherein, the rebound rate means comprises a start switch and a stop switch; the start switch located on the actuator and the stop switch located on the actuator at a preset distance above the start switch; the start switch and stop switch being activatable by the actuator shaft when the actuator shaft travels past the start switch and the stop switch respectively; and, a timer unit connected to the start switch and stop switch to measure the time period taken for the mattress-engaging pads to travel the preset distance.

8. (canceled)

9. The mattress measurement tool as claimed in claim 1, wherein, the mattress measurement tool comprises a pair of mattress-engaging pads, whereby the pair of mattress-engaging pads are arranged at the free ends of the cross-member with a gap therebetween.

10. The mattress measurement tool as claimed in claim 1, wherein, the actuator is a pneumatic ram.

11. A method of measuring a conformity characteristic of a mattress using the mattress measurement tool of claim 1, wherein, the method comprises the steps of:
actuating the actuator to indent the mattress-engaging pads into the mattress under measurement; and,
determining the deflection of the mattress under measurement when the mattress engaging pads are indented to measure the conformity characteristic of the mattress.

12. A method of measuring a conformity characteristic of a mattress using the mattress measurement tool of claim 1, wherein, the method comprises the steps of:
vertically adjusting the arm on the mast so that the mattress-engaging pads rest on the mattress under measurement;
measuring the distance from the prescribed point on the mattress measurement tool to a selected point on the mattress under measurement, where the selected point is substantially between the mattress-engaging pads;
actuating the actuator to indent the mattress-engaging pads into the mattress under measurement;
measuring the distance from the prescribed point on the mattress measurement tool to the selected point on the mattress under measurement; and,
determining the deflection of the mattress under measurement, by calculating the difference in the distance from the prescribed point to the selected point, when the mattress-engaging pads are resting on the mattress under measurement, and, when the mattress engaging pads are indented into the mattress under measurement, to measure the conformity characteristic of the mattress.

13. The method of measuring a conformity characteristic of a mattress as claimed in claim 12, wherein, the selected point is substantially midway between the mattress-engaging pads.

14. The method of measuring a conformity characteristic of a mattress as claimed in claim 12, wherein, the distance measuring device for measuring the distance from the prescribed point on the mattress measurement tool to the selected point on the mattress under measurement is a callipers mounted on the cross-member and arranged to measure a distance from the cross-member down to the mattress under measurement beneath the cross-member; whereby the method further comprises the steps of:
extending the callipers downwards to abut against the selected point on the mattress under measurement, when the mattress-engaging pads have been vertically adjusted to rest on the mattress under measurement;
calibrating the callipers to a zero reading point;
retracting the callipers upwards to allow the actuator to be actuated so as to indent the mattress-engaging pads into the mattress under measurement; and,
re-extending the callipers downward to abut against the selected point on the mattress under measurement so as to measure the deflection of the mattress under measurement when the mattress engaging pads are indented.

15. A method of measuring a rebound characteristic of a mattress using the mattress measurement tool of claim 1, wherein, the method comprises the steps of:
vertically adjusting the arm on the mast so that the mattress-engaging pads are positioned over the mattress under measurement;
actuating the actuator to extend the actuator shaft downward so that the mattress-engaging pads indent into the mattress under measurement;
releasing the actuator to cease the extension of the actuator shaft downward and immediately actuating the actuator to retract the actuator shaft in a upward direction such that the force of retracting the actuator shaft in the upward direction is substantially equal to the weight of the substantially horizontal cross-member and the mattress-engaging pads which are supported from the actuator shaft, thus simulating the mattress-engaging pads to be weightless; and,
measuring the rebound characteristic of the mattress under measurement, when the mattress-engaging pads have been simulated to be weightless and the mattress under measurement is solely acting to move the mattress-engaging pads in an upward direction.

16. The method of measuring a rebound characteristic of a mattress as claimed in claim 15, wherein, the step of measuring the rebound characteristic of the mattress under measurement is achieved by measuring the speed of the mattress-engaging pads moving in the upward direction.

17. The method of measuring a rebound characteristic of a mattress as claimed in claim 15, wherein, the step of measuring the rebound characteristic of the mattress under measurement is achieved by measuring the time period taken for the mattress-engaging pads to move a preset distance in the upward direction.

18. The method of measuring a rebound characteristic of a mattress as claimed in any of claim 17, wherein, the method further comprises the steps of:
using the actuator shaft to activate a start switch of a timer;
using the actuator shaft to subsequently activate a stop switch on the timer, where the stop switch is located a present distance above the start switch; and,
determining the time period taken for the mattress-engaging pads to move the preset distance in the upward direction to indicate the rebound characteristic for the mattress.

19. The method of measuring a rebound characteristic of a mattress as claimed in claim 18, wherein, the actuator shaft is used to activate a lower reed switch acting as the start switch and an upper reed switch acting as the stop switch, where both the lower and upper reed switches are located on the actuator, and, the output signals from both the lower and upper reed switches are transmitted to a signal-controlled timer.

20. The method of measuring a rebound characteristic of a mattress as claimed in claim 19, wherein, the timer comprises signal cancellation means to filter the output signals from both the lower and upper reed switches so as to remove noise and spurious signals and produce a single start signal and single stop signal.

21. The method of measuring a rebound characteristic of a mattress as claimed in claim 15, wherein, the step of actuating the actuator to extend the actuator shaft downward so that the mattress-engaging pads indent into the mattress under measurement comprises indenting the mattress-engaging pads into the mattress under measurement to a depth in the range of 75 mm to 100 mm.

22. The method of measuring a rebound characteristic of a mattress as claimed in claim 15, wherein, the step of actuating the actuator to extend the actuator shaft downward so that the mattress-engaging pads indent into the mattress under measurement comprises indenting the mattress-engaging pads into the mattress under measurement to a depth of substantially 85 mm.
